(19) United States
(12) Patent Application Publication
(10) Pub. No.: US 2024/0198532 A1
(43) Pub. Date: Jun. 20, 2024

(54) METHOD FOR ROBOT TELEOPERATION CONTROL, ROBOT, AND ELECTRONIC DEVICE

(71) Applicant: UBTECH ROBOTICS CORP LTD, Shenzhen (CN)

(72) Inventors: MENG YAN, Shenzhen (CN); Chunyu Chen, Shenzhen (CN); Jiangchen Zhou, Shenzhen (CN); Lihua Lu, Shenzhen (CN)

(21) Appl. No.: 18/518,960

(22) Filed: Nov. 25, 2023

(30) Foreign Application Priority Data
Dec. 20, 2022 (CN) 202211643480.4

(51) Int. Cl. B25J 9/16

(52) U.S. Cl. CPC B25J 9/1689

(57) ABSTRACT

A method for robot telcoperation control is provided. The method includes acquiring target action data and displacement data of a target object, wherein the target action data includes head action data and arm action data; controlling a target robot to act according to the target action data to enable the target robot to complete an action corresponding to the target action data; and performing centroid trajectory planning on the target robot based on a model predictive control (MPC) algorithm according to the displacement data to obtain a target centroid trajectory, and establishing a spring-damping system to track the target centroid trajectory so as to enable the target robot to move to a position corresponding to the displacement data.

### CROSS REFERENCE TO RELATED APPLICATIONS

The present disclosure claims the benefit of priority under the Paris Convention to Chinese Patent Application No. 202211643480.4 filed on Dec. 20, 2022, which is incorporated herein by reference in its entirety.

### BACKGROUND

### 1. Technical Field

The present disclosure relates to the field of robots, and more specifically to a method and apparatus for robot teleoperation control, a robot, and an electronic device.

### 2. Description of Related Art

A humanoid robot Walker has a highly human-like appearance and structure, and has structures such as a head, a trunk, arms, palms, legs, soles and the like to realize an anthropomorphic motion. The humanoid robot is able to replace a human to perform some high-risk activities, but the current level of technology is insufficient to support the robot to make completely autonomous decisions in complex environments, and human participation is still needed to control the robot to complete complex tasks.

### BRIEF DESCRIPTION OF THE DRAWINGS

The drawings described herein are used to provide a further understanding of the present disclosure, which constitute a part of the present disclosure, and illustrative embodiments of the present disclosure and descriptions thereof are used to explain the present disclosure, and do not constitute an improper limitation on the present disclosure.

FIG. 1 is a flowchart of a method for robot teleoperation control according to an embodiment of the present disclosure.

FIG. 2 is a block diagram of a method for robot teleoperation control according to an embodiment of the present disclosure.

FIG. 3 is a schematic diagram of wearing an inertial motion capture device of a method for robot teleoperation control according to an embodiment of the present disclosure.

FIG. 4 is a flowchart of data conversion of an inertial motion capture device of a method for robot teleoperation control according to an embodiment of the present disclosure.

FIG. 5 is a flowchart of a teleoperation control strategy for a whole-body remote robot of a method for robot teleoperation control according to an embodiment of the present disclosure.

FIG. 6 is a schematic structural diagram of an apparatus for robot teleoperation control according to an embodiment of the present disclosure.

FIG. 7 is a schematic structural diagram of a robot according to an embodiment of the present disclosure.

FIG. 8 is a schematic diagram of an electronic device according to an embodiment of the present disclosure.

### DETAILED DESCRIPTION

In order to make a person skilled in the art better understand the technical solutions of the present disclosure, the technical solutions in the embodiments of the present disclosure will be clearly and completely described below with reference to the accompanying drawings in the embodiments of the present disclosure. All other embodiments obtained by a person of ordinary skill in the art based on the embodiments of the present disclosure without creative efforts shall fall within the protection scope of the present disclosure.

It should be noted that the terms ‘first’, ‘second’ and the like in the specification, claims and accompanying drawings of the present disclosure are used to distinguish similar objects and are not necessarily to be used to describe a specific sequence or order. It should be understood that the data used in this way can be interchanged under appropriate circumstances so that the embodiments of the present disclosure described herein can be implemented in an order other than those illustrated or described herein. Furthermore, the terms ‘include’, ‘comprise’, ‘have’ and any variations thereof are intended to cover non-exclusive inclusion, for example, processes, methods, systems, products, or devices that include a series of steps or units are not necessarily limited to those steps or units clearly listed, but may include other steps or units not expressly listed or inherent to these processes, methods, products, or devices.

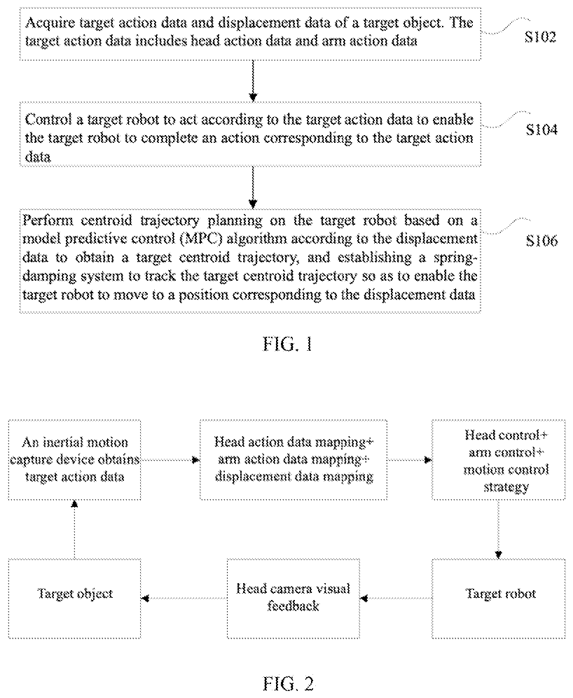

According to a first aspect of the embodiments of the present disclosure, a method for robot teleoperation control. In some embodiments, as shown in FIG. 1, the method includes the following operations.

S102: acquiring target action data and displacement data of a target object. The target action data includes head action data and arm action data.

S104: controlling a target robot to act according to the target action data to enable the target robot to complete an action corresponding to the target action data.

S106: performing centroid trajectory planning on the target robot based on a model predictive control (MPC) algorithm according to the displacement data to obtain a target centroid trajectory, and establishing a spring-damping system to track the target centroid trajectory so as to enable the target robot to move to a position corresponding to the displacement data.

In some embodiments, as shown in FIG. 2, an overall technical solution of whole-body remote teleoperation is provided. The target object wears an inertial motion capture device, and whole-body motion data (i.e., the target action data and the displacement data) of the target object is obtained through the inertial motion capture device. The target action data and the displacement data are transmitted to a main controller on a computer in real time, and the main controller converts collected target action data and displacement data into a workspace of the target robot to obtain a desired motion trajectory. The main controller on the computer resolves the desired motion trajectory of the target robot by means of a whole-body motion control strategy, to obtain control data of each joint of the target robot, and sends the obtained control data of each joint to the target robot at a remote location through a wireless local area network, so as to enable the target robot to complete the actions and motion trajectory corresponding to the desired motion trajectory, thus realizing real-time control of the target robot.

In some embodiments, the inertial motion capture device collects data via inertial posture sensors, and each sensor is internally provided with a high-dynamic triaxial accelerometer, a high-dynamic triaxial gyroscope and a high-dynamic triaxial magnetometer. The operator stands in front of the computer and wears the posture sensors on corresponding joints of the target object respectively, which are able to provide data of each joint, such as acceleration, angular velocity, etc., and high-precision motion data is able to be calculated by a nine-axis data fusion algorithm and a Kalman filtering algorithm.

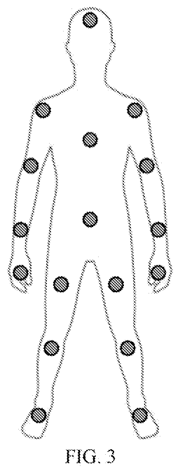

In some embodiments, a schematic diagram of the target object wearing the inertial motion capture device is shown in FIG. 3, in which 17 inertial posture sensors are worn on joints of the head, both shoulders, both upper arms, both lower arms, both palm centers, the back, the waist, both thighs, both calves, both feet and the like of the target object respectively, and motion posture data of the target object is captured in real time through the sensors to obtain the head action data, the arm action data and the displacement data of the target object.

In some embodiments, the whole-body motion data of the target object is obtained and mapped to the target robot to control the target robot to act, so as to enable the target robot to complete the same action of the target object, thereby improving flexibility, real-time performance and accuracy of completing tasks by the target robot. Therefore, the purpose of remote teleoperation of the target object to the target robot is achieved, and the technical problem that whole-body teleoperation of the robot is unable to be achieved in the existing technologies is solved.

In some embodiments, before acquiring the target action data of the target object, the method further includes: acquiring head calibration action data, arm calibration action data and calibration position data of the target object; controlling a head action of the target robot according to the head calibration action data to enable a head of the target robot to complete the head action corresponding to the head calibration action data; controlling an arm action of the target robot according to the arm calibration action data to enable arms of the target robot to complete the arm action corresponding to the arm calibration action data; establishing a human body coordinate system with the calibration position data as an origin; and establishing a robot coordinate system with calibration position data of the target robot as an origin.

In some embodiments, when the program is initialized, the target object needs to perform calibration actions to eliminate wearing errors of the sensors on the body, and then data of the head, the arms and the waist of the human body at the moment is recorded to obtain the head calibration action data, the arm calibration action data and the calibration position data. A head action of the target robot is controlled according to the head calibration action data, and an arm action of the target robot is controlled according to the arm calibration action data, so as to initialize the target robot. A human body coordinate system is established with the current position of the waist (i.e., the calibration position data) as an origin, and a robot coordinate system is established with calibration position data of the target robot as an origin. When the head of the target object acts, a rotation angle of the head is mapped to a head joint of the robot to adjust field of view of a head camera. When the arms of the target object act, rotation angles of arm joints are mapped to mechanical arm joints of the target robot by rules to control the mechanical arms to perform specific operations. When the target object moves, the displacement of the waist is mapped into the robot coordinate system from the human body coordinate system to control the robot to move to a specified position.

In some embodiments, acquiring the displacement data of the target object includes: acquiring motion posture data and skeleton data of the target object; calculating a joint rotation matrix of the target object according to a data fusion algorithm, a filtering algorithm and the motion posture data; calculating a skeleton vector of the target object according to the skeleton data; and calculating a product of the joint rotation matrix and the skeleton vector to obtain the displacement data.

In some embodiments, after the motion posture data of the target object is captured in real time through the sensors, a rotation matrix of each joint of the target object is obtained through the data fusion algorithm and the filtering algorithm. The skeleton data of the target object is measured in advance, including data such as body length, head length, neck length, shoulder width, upper arm length, lower arm length, waist width, thigh length, shank length, ankle height, foot length and the like, and is recorded in the program to obtain the skeleton vector of the target object. The displacement data of the target object is obtained through multiplication of the skeleton vector and the rotation matrix.

In some embodiments, controlling the target robot to act according to the target action data includes: controlling the target robot to act according to the head action data to enable a head of the target robot to complete an action corresponding to the head action data; and controlling the target robot to act according to the arm action data to enable arms of the target robot to complete an action corresponding to the arm action data.

In some embodiments, performing centroid trajectory planning on the target robot based on the MPC algorithm according to the displacement data to obtain the target centroid trajectory and establishing the spring-damping system to track the target centroid trajectory so as to enable the target robot to move to the position corresponding to the displacement data includes: mapping the displacement data into a human body coordinate system to obtain mapped displacement data; mapping the mapped displacement data into a robot coordinate system to obtain the target centroid trajectory; and controlling the target robot to act according to the target centroid trajectory to enable the target robot to move to the position corresponding to the displacement data.

Model Predictive Control (MPC) is also known as Moving Horizon Control (MHC), and key factors of MPC are model, objective, and constraints. A basic principle of the MPC algorithm is described as follows.

Firstly, an optimization model of the system is established, and in each discrete control cycle, information of a current system state is obtained. A desired reference trajectory is taken as an objective, feasibility constraints are considered, and a constraint optimization problem in finite time domain is solved online. N optimal input sequences in a predicted time domain obtained by solving this constraint optimization problem are control inputs of the system, and a first value of the obtained sequences is used as a control input of the system at a next moment. The above process is repeated in a next control cycle to continuously update the system state for solving. A specific scheme is described as follows.

Firstly, an upper body of the humanoid robot is simplified to a single mass point, and the feet are simplified to a three-dimensional linear inverted pendulum, so as to simplify the humanoid robot to a single mass point three-dimensional linear inverted pendulum model, and dynamically model the humanoid robot to obtain a system model. A state quantity of this model is a centroid position of the robot. The waist data acquired by the motion capture device is used as a desired reference trajectory, and the control of the centroid position tracking the reference trajectory and a foot landing point is taken as an introduced optimization objective. The constraints include that the Zero Moment Point (ZMP) of the robot should always be kept in a foot support polygon during the robot's moving process, as well as a kinematics constraint of the legs of the robot. The constraint optimization problem is solved to obtain a planned centroid trajectory. The humanoid robot realizes the control of positions and postures of the centroid and the feet through the movement of the leg joints, but errors and hysteresis between an actual trajectory and the desired trajectory of the centroid may be generated due to the hysteresis of joint tracking and other factors. The planned desired centroid trajectory and the actual trajectory are equivalent to a spring-damping model to get a final desired position of the centroid, and then a corresponding leg joint angle is able to be obtained through inverse kinematics.

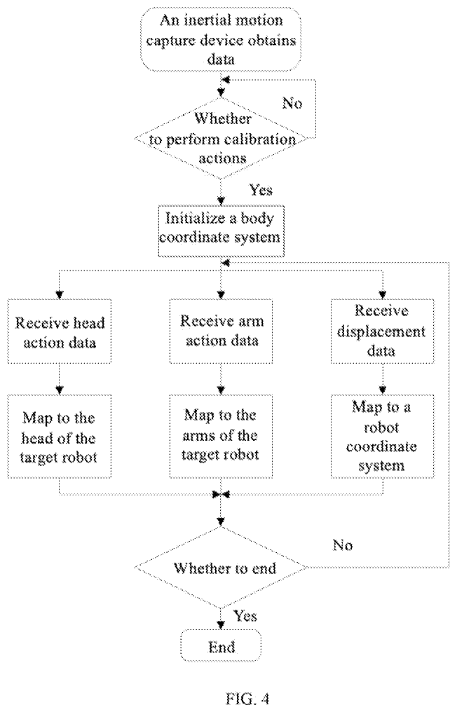

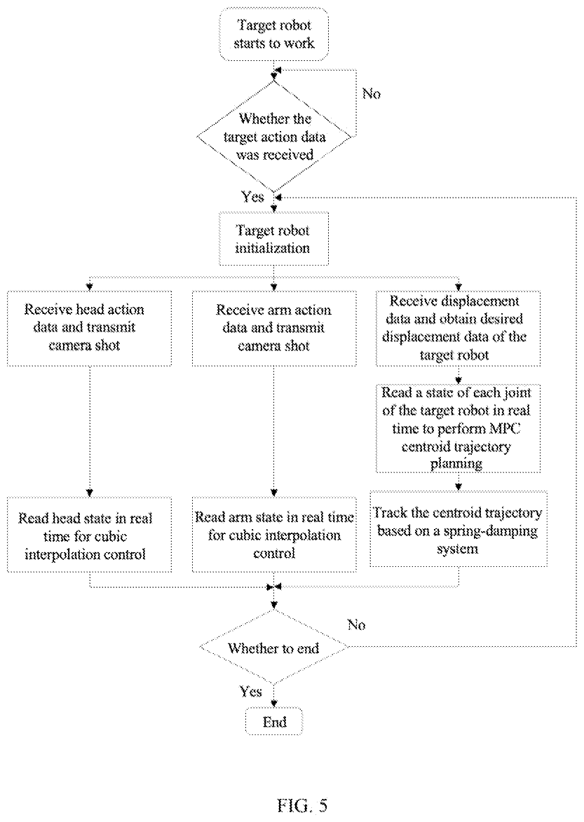

In some embodiments, the target action data collected by the inertial motion capture device is located in the human body coordinate system and needs to be mapped to the robot coordinate system, and data conversion therein is divided into three parts, i.e., head action data conversion, arm action data conversion and displacement data conversion. A specific flowchart of the data conversion is shown in FIG. 4, a flowchart of a control strategy is shown in FIG. 5, and the control is performed according to the target action data. The mapped head action data is received, and the head of the target robot is controlled through a cubic interpolation curve. Meanwhile, the mapped arm action data is received, and the mechanical arms of the target robot are controlled through the cubic interpolation curve to guarantee smooth and safe operation of the mechanical arms. When the target object moves, the displacement data of the target object in the human body coordinate system is mapped into the robot coordinate system to obtain expected displacement data in the robot coordinate system. Meanwhile, each joint state of the target robot is read in real time, and the centroid trajectory of the target robot is planned based on the MPC algorithm. Then, the spring-damping system is established to track the planned centroid trajectory. Finally, the calculated control data of hip and leg joints is sent to the target robot to enable the target robot to move to the expected position.

In some embodiments, the method further includes controlling a head camera of the target robot to photograph to obtain field of view data; and sending the field of view data to a target device.

In some embodiments, the target device includes a mobile phone, a computer, or the like. The screen shot by the head camera of the target robot is transmitted back to the computer in real time through the wireless local area network and displayed on the display of the computer, so that an operator standing in front of the computer is able to obtain environment information around the target robot and adjust according to the environment where the target robot is located.

It should be noted that, all of the method embodiments described above are expressed as a series of action combinations for simplicity of description, but those skilled in the art should understand that the present disclosure is not limited by the described action sequence, because some operations may be performed in other sequences or at the same time according to the present disclosure. Secondly, those skilled in the art should also know that the embodiments described in the specification are all preferred embodiments, and the involved actions and modules are not necessarily required by the present disclosure.

According to another aspect of the embodiments of the present disclosure, an apparatus for robot teleoperation control is provided, as shown in FIG. 6.

The apparatus for robot teleoperation control includes a first acquiring module 602, configured to acquire target action data and displacement data of a target object, wherein the target action data includes head action data and arm action data; a first control module 604, configured to control a target robot to act according to the target action data to enable the target robot to complete an action corresponding to the target action data; and a moving module 606, configured to perform centroid trajectory planning on the target robot based on a model predictive control (MPC) algorithm according to the displacement data to obtain a target centroid trajectory, and establish a spring-damping system to track the target centroid trajectory so as to enable the target robot to move to a position corresponding to the displacement data.

In some embodiments, the target object wears an inertial motion capture device, and whole-body motion data (i.e., the target action data and the displacement data) of the target object is obtained through the inertial motion capture device. The target action data and the displacement data are transmitted to a main controller on a computer in real time, and the main controller converts collected target action data and displacement data into a workspace of the target robot to obtain a desired motion trajectory. The main controller on the computer resolves the desired motion trajectory of the target robot by means of a whole-body motion control strategy, to obtain control data of each joint of the target robot, and sends the obtained control data of each joint to the target robot at a remote location through a wireless local area network, so as to enable the target robot to complete the actions and motion trajectory corresponding to the desired motion trajectory, thus realizing real-time control of the target robot.

In some embodiments, the inertial motion capture device collects data via inertial posture sensors, and each sensor is internally provided with a high-dynamic triaxial accelerometer, a high-dynamic triaxial gyroscope and a high-dynamic triaxial magnetometer. The operator stands in front of the computer and wears the posture sensors on corresponding joints of the target object respectively, which are able to provide data of each joint, such as acceleration, angular velocity, etc., and high-precision motion data is able to be calculated by a nine-axis data fusion algorithm and a Kalman filtering algorithm.

In some embodiments, 17 inertial posture sensors are worn on joints of the head, both shoulders, both upper arms, both lower arms, both palm centers, the back, the waist, both thighs, both calves, both feet and the like of the target object respectively, and motion posture data of the target object is captured in real time through the sensors to obtain the head action data, the arm action data and the displacement data of the target object.

In some embodiments, the whole-body motion data of the target object is obtained and mapped to the target robot to control the target robot to act, so as to enable the target robot to complete the same action of the target object, thereby improving flexibility, real-time performance and accuracy of completing tasks by the target robot. Therefore, the purpose of remote teleoperation of the target object to the target robot is achieved, and the technical problem that whole-body teleoperation of the robot is unable to be achieved in the existing technologies is solved.

In some embodiments, the apparatus further includes: a second acquiring module, configured to acquire head calibration action data, arm calibration action data and calibration position data of the target object before acquiring the target action data of the target object; a second control module, configured to control a head action of the target robot according to the head calibration action data to enable a head of the target robot to complete the head action corresponding to the head calibration action data, and control an arm action of the target robot according to the arm calibration action data to enable arms of the target robot to complete the arm action corresponding to the arm calibration action data; a first establishing module, configured to establish a human body coordinate system with the calibration position data as an origin; and a second establishing module, configured to establish a robot coordinate system with calibration position data of the target robot as an origin.

In some embodiments, when the program is initialized, the target object needs to perform calibration actions to eliminate wearing errors of the sensors on the body, and then data of the head, the arms and the waist of the human body at the moment is recorded to obtain the head calibration action data, the arm calibration action data and the calibration position data. A head action of the target robot is controlled according to the head calibration action data, and an arm action of the target robot is controlled according to the arm calibration action data, so as to initialize the target robot. A human body coordinate system is established with the current position of the waist (i.e., the calibration position data) as an origin, and a robot coordinate system is established with calibration position data of the target robot as an origin. When the head of the target object acts, a rotation angle of the head is mapped to a head joint of the robot to adjust field of view of a head camera. When the arms of the target object act, rotation angles of arm joints are mapped to mechanical arm joints of the target robot by rules to control the mechanical arms to perform specific operations. When the target object moves, the displacement of the waist is mapped into the robot coordinate system from the human body coordinate system to control the robot to move to a specified position.

In some embodiments, the first acquiring module includes: an acquiring unit, configured to acquire motion posture data and skeleton data of the target object; a first calculation unit, configured to calculate a joint rotation matrix of the target object according to a data fusion algorithm, a filtering algorithm and the motion posture data; a second calculation unit, configured to calculate a skeleton vector of the target object according to the skeleton data; and a third calculation unit, configured to calculate a product of the joint rotation matrix and the skeleton vector to obtain the displacement data.

In some embodiments, after the motion posture data of the target object is captured in real time through the sensors, a rotation matrix of each joint of the target object is obtained through the data fusion algorithm and the filtering algorithm. The skeleton data of the target object is measured in advance, including data such as body length, head length, neck length, shoulder width, upper arm length, lower arm length, waist width, thigh length, shank length, ankle height, foot length and the like, and is recorded in the program to obtain the skeleton vector of the target object. The displacement data of the target object is obtained through multiplication of the skeleton vector and the rotation matrix.

In some embodiments, the first control module includes: a first control unit, configured to the target robot to act according to the head action data to enable a head of the target robot to complete an action corresponding to the head action data; and a second control unit, configured to control the target robot to act according to the arm action data to enable arms of the target robot to complete an action corresponding to the arm action data.

In some embodiments, the moving module includes: a mapping unit, configured to map the displacement data into a human body coordinate system to obtain mapped displacement data, and map the mapped displacement data into a robot coordinate system to obtain the target centroid trajectory: and a third control unit, configured to control the target robot to act according to the target centroid trajectory to enable the target robot to move to the position corresponding to the displacement data.

In some embodiments, the target action data collected by the inertial motion capture device is located in the human body coordinate system and needs to be mapped to the robot coordinate system, data conversion therein is divided into three parts, i.e., head action data conversion, arm action data conversion and displacement data conversion, and the control is performed according to the target action data. The mapped head action data is received, and the head of the target robot is controlled through a cubic interpolation curve. Meanwhile, the mapped arm action data is received, and the mechanical arms of the target robot are controlled through the cubic interpolation curve to guarantee smooth and safe operation of the mechanical arms. When the target object moves, the displacement data of the target object in the human body coordinate system is mapped into the robot coordinate system to obtain expected displacement data in the robot coordinate system. Meanwhile, each joint state of the target robot is read in real time, and the centroid trajectory of the target robot is planned based on the MPC algorithm. Then, the spring-damping system is established to track the planned centroid trajectory. Finally, the calculated control data of hip and leg joints is sent to the target robot to enable the target robot to move to the expected position.

In some embodiments, the apparatus further includes: a third control module, configured to control a head camera of the target robot to photograph to obtain field of view data; and a sending module, configured to send the field of view data to a target device.

In some embodiments, the target device includes a mobile phone, a computer, or the like. The screen shot by the head camera of the target robot is transmitted back to the computer in real time through the wireless local area network and displayed on the display of the computer, so that an operator standing in front of the computer is able to obtain environment information around the target robot and adjust according to the environment where the target robot is located.

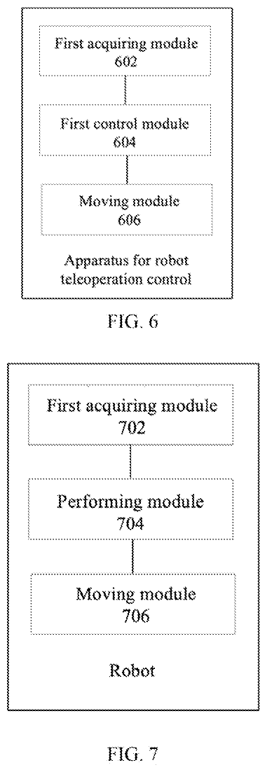

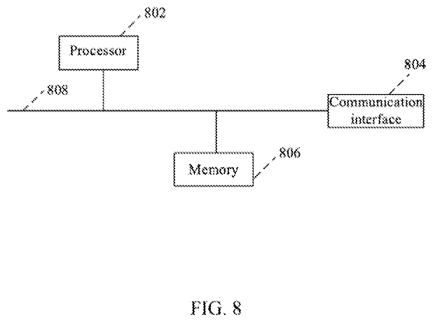

According to another aspect of the embodiments of the present disclosure, a robot is provided, as shown in FIG. 7.

The robot includes a memory and at least one processor coupled to the memory, and the at least one processor executing instructions stored in the memory to provide: a first acquiring module 702, configured to acquire target action data and displacement data of a target object, where the target action data includes head action data and arm action data; a performing module 704, configured to perform a target action according to the target action data; and a moving module 706, configured to perform centroid trajectory planning on the target robot based on a model predictive control (MPC) algorithm according to the displacement data to obtain a target centroid trajectory, establish a spring-damping system, and move to a position corresponding to the displacement data according to the target centroid trajectory.

In some embodiments, the target object wears an inertial motion capture device, and whole-body motion data (i.e., the target action data and the displacement data) of the target object is obtained through the inertial motion capture device. The target action data and the displacement data are converted into a workspace of the target robot to obtain a desired motion trajectory. The desired motion trajectory is calculated through the whole-body motion control strategy to obtain the control data of each joint of the target robot, and the target action is executed according to the control data of each joint to enable the target robot to complete the action and the motion trajectory corresponding to the desired motion trajectory.

In some embodiments, the inertial motion capture device collects data via inertial posture sensors, and each sensor is internally provided with a high-dynamic triaxial accelerometer, a high-dynamic triaxial gyroscope and a high-dynamic triaxial magnetometer. The operator stands in front of the computer and wears the posture sensors on corresponding joints of the target object respectively, which are able to provide data of each joint, such as acceleration, angular velocity, etc., and high-precision motion data is able to be calculated by a nine-axis data fusion algorithm and a Kalman filtering algorithm.

In some embodiments, 17 inertial posture sensors are worn on joints of the head, both shoulders, both upper arms, both lower arms, both palm centers, the back, the waist, both thighs, both calves, both feet and the like of the target object respectively, and motion posture data of the target object is captured in real time through the sensors to obtain the head action data, the arm action data and the displacement data of the target object.

In some embodiments, the whole-body motion data of the target object is obtained and mapped to the target robot, and the target robot executes the target action according to the target action data, so that the target robot completes the same action of the target object, thereby improving flexibility, real-time performance and accuracy of completing tasks by the target robot. Therefore, the purpose of remote teleoperation of the target object to the target robot is achieved, and the technical problem that whole-body teleoperation of the robot is unable to be achieved in the existing technologies is solved.

In some embodiments, the robot further includes: a second acquiring module, configured to acquire head calibration action data, arm calibration action data and calibration position data of the target object before acquiring the target action data of the target object; a second control module, configured to control a head action of the robot according to the head calibration action data to enable a head of the robot to complete the head action corresponding to the head calibration action data, and control an arm action according to the arm calibration action data to enable arms of the robot to complete the arm action corresponding to the arm calibration action data; a first establishing module, configured to establish a human body coordinate system with the calibration position data as an origin; and a second establishing module, configured to establish a robot coordinate system with calibration position data of the target robot as an origin.

In some embodiments, when the program is initialized, the target object needs to perform calibration actions to eliminate wearing errors of the sensors on the body, and then data of the head, the arms and the waist of the human body at the moment is recorded to obtain the head calibration action data, the arm calibration action data and the calibration position data. A head action of the target robot is controlled according to the head calibration action data, and an arm action of the target robot is controlled according to the arm calibration action data, so as to initialize the target robot. A human body coordinate system is established with the current position of the waist (i.e., the calibration position data) as an origin, and a robot coordinate system is established with calibration position data of the target robot as an origin. When the head of the target object acts, a rotation angle of the head is mapped to a head joint of the robot to adjust field of view of a head camera. When the arms of the target object act, rotation angles of arm joints are mapped to mechanical arm joints of the target robot by rules to control the mechanical arms to perform specific operations. When the target object moves, the displacement of the waist is mapped into the robot coordinate system from the human body coordinate system to control the robot to move to a specified position.

In some embodiments, the first acquiring module includes: an acquiring unit, configured to acquire motion posture data and skeleton data of the target object; a first calculation unit, configured to calculate a joint rotation matrix of the target object according to a data fusion algorithm, a filtering algorithm and the motion posture data; a second calculation unit, configured to calculate a skeleton vector of the target object according to the skeleton data; and a third calculation unit, configured to calculate a product of the joint rotation matrix and the skeleton vector to obtain the displacement data.

In some embodiments, after the motion posture data of the target object is captured in real time through the sensors, a rotation matrix of each joint of the target object is obtained through the data fusion algorithm and the filtering algorithm. The skeleton data of the target object is measured in advance, including data such as body length, head length, neck length, shoulder width, upper arm length, lower arm length, waist width, thigh length, shank length, ankle height, foot length and the like, and is recorded in the program to obtain the skeleton vector of the target object. The displacement data of the target object is obtained through multiplication of the skeleton vector and the rotation matrix.

In some embodiments, the performing module includes: a first control unit, configured to control a head action according to the head action data to enable the head to complete the head action corresponding to the head action data; and a second control unit, configured to control an arm action according to the arm action data to enable the arm to complete the arm action corresponding to the arm action data.

In some embodiments, the moving module includes: a mapping unit, configured to map the displacement data into a human body coordinate system to obtain mapped displacement data, and map the mapped displacement data into a robot coordinate system to obtain the target centroid trajectory; and a moving unit, configured to move to a target position corresponding to the displacement data according to the target centroid trajectory.

In some embodiments, the target action data collected by the inertial motion capture device is located in the human body coordinate system and needs to be mapped to the robot coordinate system, data conversion therein is divided into three parts, i.e., head action data conversion, arm action data conversion and displacement data conversion, and the control is performed according to the target action data. The mapped head action data is received, and the head of the target robot is controlled through a cubic interpolation curve. Meanwhile, the mapped arm action data is received, and the mechanical arms of the target robot are controlled through the cubic interpolation curve to guarantee smooth and safe operation of the mechanical arms. When the target object moves, the displacement data of the target object in the human body coordinate system is mapped into the robot coordinate system to obtain expected displacement data in the robot coordinate system. Meanwhile, each joint state of the target robot is read in real time, and the centroid trajectory of the target robot is planned based on the MPC algorithm. Then, the spring-damping system is established to track the planned centroid trajectory. Finally, the calculated control data of hip and leg joints is sent to the target robot to enable the target robot to move to the expected position.

In some embodiments, the robot further includes: a second control module, configured to control a head camera to photograph to obtain field of view data; and a sending module, configured to send the field of view data to a target device.

In some embodiments, the target device includes a mobile phone, a computer, or the like. The screen shot by the head camera of the target robot is transmitted back to the computer in real time through the wireless local area network and displayed on the display of the computer, so that an operator standing in front of the computer is able to obtain environment information around the target robot and adjust the target robot according to the environment where the target robot is located through the computer.

Other embodiments regarding to the robot may be referred to the above embodiments regarding to the apparatus, which are not described herein in details.

FIG. 8 is a schematic diagram of an electronic device according to an embodiment of the present disclosure. As shown in FIG. 8, the electronic device includes a processor 802, a communication interface 804, a memory 806, and a communication bus 808. The processor 802, the communication interface 804, and the memory 806 communicate with each other through the communication bus 808.

The memory 806 is configured to store a computer program, and the processor 802 is configured to execute the computer program stored in the memory 806 perform the following operations: acquiring target action data and displacement data of a target object, wherein the target action data includes head action data and arm action data; controlling a target robot to act according to the target action data to enable the target robot to complete an action corresponding to the target action data; and performing centroid trajectory planning on the target robot based on a model predictive control (MPC) algorithm according to the displacement data to obtain a target centroid trajectory, and establishing a spring-damping system to track the target centroid trajectory so as to enable the target robot to move to a position corresponding to the displacement data.

In some embodiments, the communication bus includes a Peripheral Component Interconnect (PCI) bus, an Extended Industry Standard Architecture (EISA) bus, or the like. The communication bus is divided into an address bus, a data bus, a control bus, and the like. For ease of representation, only one thick line is used to represent the bus in FIG. 8, but this does not mean that there is only one bus or one type of buses. The communication interface is configured for communication between the electronic device and other devices.

The memory includes a Random Access Memory (RAM), or includes a non-volatile memory, for example, at least one disk memory. In some embodiments, the memory includes at least one storage device located away from the processor.

As an example, the memory 806 includes, but is not limited to, a first acquiring module 602, a first control module 604, and a moving modale 606 in the apparatus for robot teleoperation control, and may further include, but is not limited to, other modules/units in the apparatus for robot teleoperation control, and details are not described in this example.

The processor may be a general-purpose processor, which includes, but is not limited to, a Central Processing Unit (CPU), a Network Processor (NP), or the like, or the processor may be a Digital Signal Processor (DSP), an Application Specific Integrated Circuit (ASIC), a Field-Programmable Gate Array (FPGA) or other programmable logic devices, discrete gates or transistor logic devices, and discrete hardware components.

Other embodiments regarding the electronic device may refer to the embodiments described above, and details are not described herein again.

A person of ordinary skill in the art may understand that the structure shown in FIG. 8 is merely a schematic, a device implementing the method for robot teleoperation control may be a terminal device, and the terminal device may be a smart phone (such as an Android mobile phone, an iOS mobile phone, etc.), a tablet computer, a palm computer, and terminal devices such as a mobile Internet device (MID) and a Pad. FIG. 8 does not limit the structure of the electronic device. For example, the electronic device may also include more or fewer components (e.g., network interfaces, display devices, etc.) than shown in FIG. 8, or include different configurations as shown in FIG. 8.

A person of ordinary skill in the art may understand that all or some of the operations in the various methods of the above embodiments may be completed by instructing, by a program, hardware related to the terminal device, the program may be stored in a computer-readable storage medium, and the storage medium may include a flash disk, a Read-Only Memory (ROM), the RAM, a magnetic disk, an optical disk, and the like.

According to yet another aspect of the embodiments of the present disclosure, a computer-readable storage medium is further provided. The computer-readable storage medium stores a computer program, and the computer program when executed by the processor causes the processor to perform the operations in the method for robot teleoperation control.

In some embodiments, a person of ordinary skill in the art may understand that all or some of the steps in the various methods of the above embodiments may be completed by instructing, by a program, hardware related to the terminal device, the program may be stored in a computer-readable storage medium, and the storage medium may include the flash disk, the ROM, the RAM, the magnetic disk, the optical disk, and the like.

The sequence numbers of the embodiments of the present disclosure are merely for description, and do not represent the advantages and disadvantages of the embodiments.

If the integrated unit in the above embodiments is implemented in the form of a software functional unit and sold or used as an independent product, the integrated unit may be stored in the computer-readable storage medium. Based on such understanding, the technical solution of the present disclosure may be embodied in the form of a software product in essence, the part that contributes to the prior art, or the whole or part of the technical solution. The computer software product is stored in a storage medium, and includes several instructions for enabling one or more computer devices (which may be a personal computer, a server, or a network device, etc.) to perform all or some of the operations of the methods described in various embodiments of the present disclosure.

In the above embodiments of the present disclosure, the descriptions of the various embodiments are emphasized respectively, and some of the embodiments that are not described in detail in some embodiments may refer to related descriptions of other embodiments.

In several embodiments provided in the present disclosure, it should be understood that the disclosed client may be implemented in other manners. The apparatus embodiments described above are merely illustrative, for example, the division of the units is merely a logical function division, and there may be another division manner during actual implementation, for example, multiple units or components may be combined or may be integrated into another system, or some features may be ignored, or not performed. In addition, the mutual coupling or direct coupling or communication connection shown or discussed may be indirect coupling or communication connection through some interfaces, units or modules, and may be electrical or other forms.

The units described as separate components may or may not be physically separate, and components displayed as units may or may not be physical units, that is, may be located in one place, or may be distributed on multiple network units. Some or all of the units may be selected according to actual needs to achieve the objectives of the solutions of the embodiments.

In addition, functional units in the embodiments of the present disclosure may be integrated into one processing unit, or each of the units may exist alone physically, or two or more units may be integrated into one unit. The integrated unit may be implemented in the form of hardware, or may be implemented in the form of a software functional unit.

The above description only involves some embodiments of the present disclosure, and it should be noted that, for a person of ordinary skill in the art, several improvements and modifications are able to be made without departing from the principle of the present disclosure, and these improvements and modifications should also be regarded as the protection scope of the present disclosure.

What is claimed is:

1. A method for robot teleoperation control, comprising:
acquiring target action data and displacement data of a target object, wherein the target action data includes head action data and arm action data;
controlling a target robot to act according to the target action data to enable the target robot to complete an action corresponding to the target action data; and
performing centroid trajectory planning on the target robot based on a model predictive control (MPC) algorithm according to the displacement data to obtain a target centroid trajectory, and establishing a spring-damping system to track the target centroid trajectory so as to enable the target robot to move to a position corresponding to the displacement data.

2. The method according to claim 1, wherein before acquiring the target action data of the target object, the method further includes:
acquiring head calibration action data, arm calibration action data and calibration position data of the target object;
controlling a head action of the target robot according to the head calibration action data to enable a head of the target robot to complete the head action corresponding to the head calibration action data;
controlling an arm action of the target robot according to the arm calibration action data to enable arms of the target robot to complete the arm action corresponding to the arm calibration action data;
establishing a human body coordinate system with the calibration position data as an origin; and
establishing a robot coordinate system with calibration position data of the target robot as an origin.

3. The method according to claim 1, wherein acquiring the displacement data of the target object includes:
acquiring motion posture data and skeleton data of the target object;
calculating a joint rotation matrix of the target object according to a data fusion algorithm, a filtering algorithm and the motion posture data;
calculating a skeleton vector of the target object according to the skeleton data; and
calculating a product of the joint rotation matrix and the skeleton vector to obtain the displacement data.

4. The method according to claim 1, wherein controlling the target robot to act according to the target action data includes:
controlling the target robot to act according to the head action data to enable a head of the target robot to complete an action corresponding to the head action data; and
controlling the target robot to act according to the arm action data to enable arms of the target robot to complete an action corresponding to the arm action data.

5. The method according to claim 1, wherein performing centroid trajectory planning on the target robot based on the MPC algorithm according to the displacement data to obtain the target centroid trajectory and establishing the spring-damping system to track the target centroid trajectory so as to enable the target robot to move to the position corresponding to the displacement data includes:
mapping the displacement data into a human body coordinate system to obtain mapped displacement data;
mapping the mapped displacement data into a robot coordinate system to obtain the target centroid trajectory; and
controlling the target robot to act according to the target centroid trajectory to enable the target robot to move to the position corresponding to the displacement data.

6. The method according to claim 1, further comprising:
controlling a head camera of the target robot to photograph to obtain field of view data; and
sending the field of view data to a target device.

7. The method according to claim 6, further comprising:
obtaining information about an environment where the target robot is located according to the field of view data; and
adjusting the target robot according to the information.

8. A robot, comprising:
a memory storing a computer program; and
a processor couple to the memory, wherein the processor is configured to execute the computer program to:
acquire target action data and displacement data of a target object, wherein the target action data includes head action data and arm action data;
perform a target action according to the target action data; and
perform centroid trajectory planning on the target robot based on a model predictive control (MPC) algorithm according to the displacement data to obtain a target centroid trajectory, establish a spring-damping system, and move to a position corresponding to the displacement data according to the target centroid trajectory.

9. The robot according to claim 8, wherein the processor is further configured to:
acquire head calibration action data, arm calibration action data and calibration position data of the target object before acquiring the target action data of the target object;
control a head action of the robot according to the head calibration action data to enable a head of the robot to complete the head action corresponding to the head calibration action data, and control an arm action of the robot according to the arm calibration action data to enable arms of the robot to complete the arm action corresponding to the arm calibration action data;
establish a human body coordinate system with the calibration position data as an origin; and
establish a robot coordinate system with calibration position data of the target robot as an origin.

10. The robot according to claim 8, wherein the processor is further configured to:
acquire motion posture data and skeleton data of the target object;
calculate a joint rotation matrix of the target object according to a data fusion algorithm, a filtering algorithm and the motion posture data;
calculate a skeleton vector of the target object according to the skeleton data; and
calculate a product of the joint rotation matrix and the skeleton vector to obtain the displacement data.

11. The robot according to claim 8, wherein the processor is further configured to:
control a head action according to the head action data to enable the head to complete the head action corresponding to the head action data; and
control an arm action according to the arm action data to enable the arm to complete the arm action corresponding to the arm action data.

12. The robot according to claim 8, wherein the processor is further configured to:
map the displacement data into a human body coordinate system to obtain mapped displacement data;
map the mapped displacement data into a robot coordinate system to obtain the target centroid trajectory; and
move to a target position corresponding to the displacement data according to the target centroid trajectory.

13. The robot according to claim 8, wherein the processor is further configured to:
control a head camera to photograph to obtain field of view data; and
send the field of view data to a target device.

14. An electronic device, comprising:
a memory storing a computer program;
a processor coupled to the memory, wherein the computer program when executed by the processor causes the processor to perform a method for robot teleoperation control;
wherein the method includes:
acquiring target action data and displacement data of a target object, wherein the target action data includes head action data and arm action data;
controlling a target robot to act according to the target action data to enable the target robot to complete an action corresponding to the target action data; and
performing centroid trajectory planning on the target robot based on a model predictive control (MPC) algorithm according to the displacement data to obtain a target centroid trajectory, and establishing a spring-damping system to track the target centroid trajectory so as to enable the target robot to move to a position corresponding to the displacement data.

15. The electronic device according to claim 14, wherein before acquiring the target action data of the target object, the method further includes:
acquiring head calibration action data, arm calibration action data and calibration position data of the target object;
controlling a head action of the target robot according to the head calibration action data to enable a head of the target robot to complete the head action corresponding to the head calibration action data;
controlling an arm action of the target robot according to the arm calibration action data to enable arms of the target robot to complete the arm action corresponding to the arm calibration action data;
establishing a human body coordinate system with the calibration position data as an origin; and
establishing a robot coordinate system with calibration position data of the target robot as an origin.

16. The electronic device according to claim 14, wherein acquiring the displacement data of the target object includes:
acquiring motion posture data and skeleton data of the target object;
calculating a joint rotation matrix of the target object according to a data fusion algorithm, a filtering algorithm and the motion posture data;
calculating a skeleton vector of the target object according to the skeleton data; and
calculating a product of the joint rotation matrix and the skeleton vector to obtain the displacement data.

17. The electronic device according to claim 14, wherein controlling the target robot to act according to the target action data includes:
controlling the target robot to act according to the head action data to enable a head of the target robot to complete an action corresponding to the head action data; and
controlling the target robot to act according to the arm action data to enable arms of the target robot to complete an action corresponding to the arm action data.

18. The electronic device according to claim 14, wherein performing centroid trajectory planning on the target robot based on the MPC algorithm according to the displacement data to obtain the target centroid trajectory and establishing the spring-damping system to track the target centroid trajectory so as to enable the target robot to move to the position corresponding to the displacement data includes:
mapping the displacement data into a human body coordinate system to obtain mapped displacement data;
mapping the mapped displacement data into a robot coordinate system to obtain the target centroid trajectory; and
controlling the target robot to act according to the target centroid trajectory to enable the target robot to move to the position corresponding to the displacement data.

19. The electronic device according to claim 14, wherein the method further includes:
controlling a head camera of the target robot to photograph to obtain field of view data; and
sending the field of view data to a target device.

20. The electronic device according to claim 19, wherein the method further includes:
obtaining information about an environment where the target robot is located according to the field of view data; and
adjusting the target robot according to the information.
